(19) United States
(12) Patent Application Publication
(10) Pub. No.: US 2013/0301056 A1
(43) Pub. Date: Nov. 14, 2013

(54) NONCONTACT INTERFEROMETRIC SENSOR AND METHOD OF USE

(71) Applicant: Robert E. Parks, Tucson, AZ (US)

(72) Inventor: Robert E. Parks, Tucson, AZ (US)

(21) Appl. No.: 13/888,787

(22) Filed: May 7, 2013

Related U.S. Application Data
(60) Provisional application No. 61/645,278, filed on May 10, 2012.

(51) Int. Cl. G01B 9/02

(52) U.S. Cl. CPC G01B 9/02058
USPC 356/486; 356/489

(57) ABSTRACT

An interferometric sensor having an interference objective, an illumination system, and a detection system configured to simultaneous non-contact determination of profile and roughness of a tested surface. The illumination system comprises a radiation source configured to emit three wavelengths of quasi-monochromatic light. The sensor further includes a detection system having a color array detector in optical communication with the interference objective and configured to detect the light reflected by the measurand. The sensitivity of measurement can be adjusted by re-orienting of a portion of the sensor with respect to the measurand.

### CROSS-REFERENCE TO RELATED APPLICATIONS

The present application claims benefit of and priority from the U.S. provisional patent application No. 61/645,278 filed on May 10, 2012 and titled “Noncontact Interferometric Sensor and Method of Use”. The disclosure of the above-mentioned provisional patent application is incorporated herein by reference in its entirety.

### TECHNICAL FIELD

The present invention relates generally to the field of interferometry and, in particular, to an interferometric profilometer structured to measure a curvature and roughness of a free-form surface.

### BACKGROUND OF THE INVENTION

High-quality precision surfaces are often mechanically machined with the use of, for example, diamond turning lathes or other numerically controlled machine tools that are equipped with natural and/or synthetic diamond-tipped tool bits, or grinding and magneto-rheological finishing. The initial stages of this multi-stage machining process (referred to as “diamond turning”) are carried out using a series of lathes characterized by increasing accuracy. The diamond tip lathe tool is then used in the final stage to achieve sub-nanometer level surface finishes and sub-micrometer form accuracies.

As even miniscule errors in the diamond turning can result in defective parts, the quality of the fabricated elements (such as optical elements, for example) must be checked after each stage of the process. Presently, such quality checks are performed by removing the optical elements from the lathe and measuring them in a laboratory environment. The optical elements are then returned to the machine for further refinement, if the results of the measurements show that the elements do not meet specifications. The remounting of some optical elements is difficult, if not impossible, and such optical elements are often scrapped. (Indeed, elements with free-form surfaces may have no planes or axes of symmetry and, therefore, have to be aligned with all six degrees of freedom of a rigid-body motion with a micron precision with respect to translation and a few seconds of arc with respect to an angle.) Additionally, as the process is done manually, it is slow and costly, making diamond turning expensive and unsuitable for mass production. While metrological devices for measuring the finish and profile of optical elements exist (such as, for example, Zygo New View, described at www.zygo.com/?/met/profilers/newview7000; or Bruker ContourGT-1, described at http://www.bruker.com/fileadmin/user_upload/8-PDF-Docs/SurfaceAnalysis/3D-OpticalMicroscopy/DataSheets/ContourGTI_{—}3D_Optical_Microscope-Datasheet-_DS553-RevA1.pdf), these devices are not necessarily suitable for in situ metrology, because they are either too large or too heavy, require the use of a contact probe, or have a geometry that prevents them from being mounted on a lathe during the machining process.

Therefore, there remains a need in a device enabled to perform non-contact in situ profiling metrology of an optical element that is being machined (such that errors in the finish or contour of the optical element can be quickly and automatically detected and corrected before the element is taken off the lathe) or that is being characterized in the laboratory environment.

### SUMMARY

Embodiments of the invention provide a method for optically determining a descriptor of a surface of an object. The method includes receiving, with an optical detector, light that has been reflected by the object and that has traversed an interference objective having an axis. The received light characterized by three distinct wavelengths. The method further includes acquiring, with a programmable processor, first, second, and third data from the optical detector, wherein said first, second, and third optical data represent interferometric images of the object formed in light at respectively corresponding wavelengths from the three distinct wavelengths. The method additionally includes determining the descriptor of the surface based on a product of said first, second, and third data. The description of a surface of the object under test may contain a contour of the surface of the object from said fringe and/or a figure of merit characterizing roughness of the surface of the object based of deviation of a line corresponding to a center of said fringe from a straight line.

Embodiments of the invention additionally provide a method for optically determining a descriptor of a surface of an object. Such method includes (i) receiving, with an optical detector, light that has been reflected by the object and that has traversed an interference objective having an axis (where the received light is characterized by three distinct wavelengths); (ii) acquiring, with a programmable processor, first, second, and third data from the optical detector (wherein said first, second, and third optical data represent interferometric images of the object formed in light at respectively corresponding wavelengths from the three distinct wavelengths); and (iii) forming, on a display device, an image of the object based on the product of said first, second, and third data. The method additionally includes determining a fringe of said image corresponding to light that has traversed substantially equal optical paths at the three distinct wavelengths; and axially moving the interference objective with respect to the surface of the object to keep the above-defined fringe substantially in a center of a field-of-view (FOV) of the optical detector. Furthermore, the method includes determining the descriptor of the surface based on the product of the first, second, and third data.

Alternatively or in addition, the embodiments of the invention provide a non-contact interferometric sensor for optical testing of an object. Such sensor includes an interference objective having an optical axis; and an optical detection system positioned to receive light transmitted through the interference objective (wherein the received light is characterized by three distinct wavelengths). The optical detection system is operably cooperated with a data-processing unit containing a programmable processor and tangible, non-transitory computer-readable medium with computer-readable product contained thereon. The computer program product contains program code that, when loaded onto the processor, enables the data-processing unit to (i) acquire, independently from one another, three sets of data from the optical detection system, said sets respectively representing interferometric light distributions formed in light transmitted through the interference objective at respectively corresponding distinct wavelengths; and (ii) form a product of the three sets of data to produce sensor data.

### BRIEF DESCRIPTION OF THE DRAWINGS

Implementations of the invention will become more apparent from the detailed description set forth below when taken in conjunction with the drawings. The present application contains at least one drawing executed in color. Copies of this patent application with color drawings will be provided by the Office upon request and payment of the necessary fee. The drawings include:

FIG. 1A is a schematic diagram of one embodiment of the present sensor;

FIG. 1B is a schematic diagram of an alternative embodiment of the present sensor;

FIG. 2A is a drawing illustrating fringe pattern created by a monochromatic light at a single wavelength;

FIG. 2B is a drawing illustrating the fringe pattern created by a quasi-monochromatic light characterized by three distinct wavelengths;

FIG. 2C is a color-rendering of an interferometric image of an object acquired with an embodiment of a system of the invention in light the spectral content of which is defined by three distinct wavelengths.

FIG. 3 is a plot showing empirically acquired irradiance profiles corresponding to a fringe pattern of FIG. 2B in light at wavelengths in the red, green, and blue spectral regions;

FIG. 4 provides a plot chart illustrating the detrended irradiance profiles of FIG. 3 that have been fit with a non-linear least squares algorithm to determine spatial frequency and phase of each of the profiles;

FIG. 5A is a wire-diagram showing an embodiment of the invention on a movable stage in perspective view;

FIG. 5B is a “light and shadow” rendering of the embodiment of FIG. 5A;

FIGS. 6A and 6B depict a flowchart of a method for using the present sensor to determine the contour and surface roughness of a measurand using the present sensor.

FIG. 7A is a plot showing an interference fringe pattern empirically acquired with an embodiment of the invention and representing an image of the object under test in red light;

FIG. 7B is a plot showing an interference fringe pattern empirically acquired with an embodiment of the invention and representing an image of the object under test in green light;

FIG. 7C is a plot showing an interference fringe pattern empirically acquired with an embodiment of the invention and representing an image of the object under test in blue light;

FIG. 7D is a plot representing a product of the irradiance patterns of FIGS. 7A, 7B, and 7C.

FIG. 8 is a black-and-white rendering of an interferometric pattern of an image of the object under test illustrating the determination of a surface roughness according to an embodiment of the invention.

FIGS. 9A through 9D are diagrams illustrating a method of varying the sensitivity to changes in distance between the embodiment of the sensor and the object under test.

### DETAILED DESCRIPTION

The implementations of the present invention provide an active, non-contact interferometric sensor that is small and light enough and structured to be mountable on a turning or milling machine and used to measure the finish and contour of a specular free-form surface, and in particular, a surface of an chosen (for example, optical) element fixed in the turning/milling or precision CNC machine so that errors (such as those resulting from tool wear or distortion of the element due to the rotation of the element in the machine or poor finish) can be detected and corrected before the element is taken off the machine. The use of the embodiments for testing of a roughness of a surface of the element is also within the scope of the invention. While for convenience the description of the invention is presented primarily in reference to one-dimensional profiling of the optical element, one of ordinary skill in the art will appreciate that the two-dimensional scanning and profiling (resulting, for example, in a two-dimensional topographic map of the scanned free-form specularly-reflecting surface of the optical element) is also within the scope of the invention.

The term “active” is used to denote that an embodiment of the sensor is enabled to operably communicate with the system or machine on which it is mounted. The present sensor is also a null sensor and, therefore, exerts an influence on the measured system so as to oppose the effect of the measurand. Specifically, the present sensor generates an output (in a form of an electrical signal, for example, accepted by the machine), based on which a data-processing unit of the system enables the system to maintain the sensor oriented at a fixed distance from and facing towards the surface being measured along the normal to the surface during the process of mutual repositioning between the surface and the sensor (for example, during the optical scanning of the surface). For example, as discussed below in more detail, an optical portion of the sensor can be configured to be repositionable and/or moveable along an optical axis, for example with the use of a piezoelectric transducer juxtaposed to and enabling the repositioning of the optical objective. The output of the sensor (required to maintain the distance and direction from the surface under test) is generated in response to an optical wavefront caused by reflection of light from an area of the specularly-reflecting surface under test and interfering with another wavefront associated with the reference mirror of the interferometric sensor. The reflected, interfering beams use light of different frequencies to unambiguously maintain a fixed distance and direction of the sensor from the surface being profiled.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In the drawings like numbers are used to represent the same or similar elements wherever possible. The depicted structural elements are generally not to scale, and certain components are enlarged relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed. Furthermore, the described single features, structures, or characteristics of the invention may be combined in any suitable manner in one or more further embodiments.

Moreover, if the schematic flow chart diagram is included, it is generally set forth as a logical flow-chart diagram. As such, the depicted order and labeled steps of the logical flow are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Without loss of generality, the order in which processing steps or particular methods occur may or may not strictly adhere to the order of the corresponding steps shown.

The invention as recited in claims appended to this disclosure is intended to be assessed in light of the disclosure as a whole, including features disclosed in prior art to which reference is made.

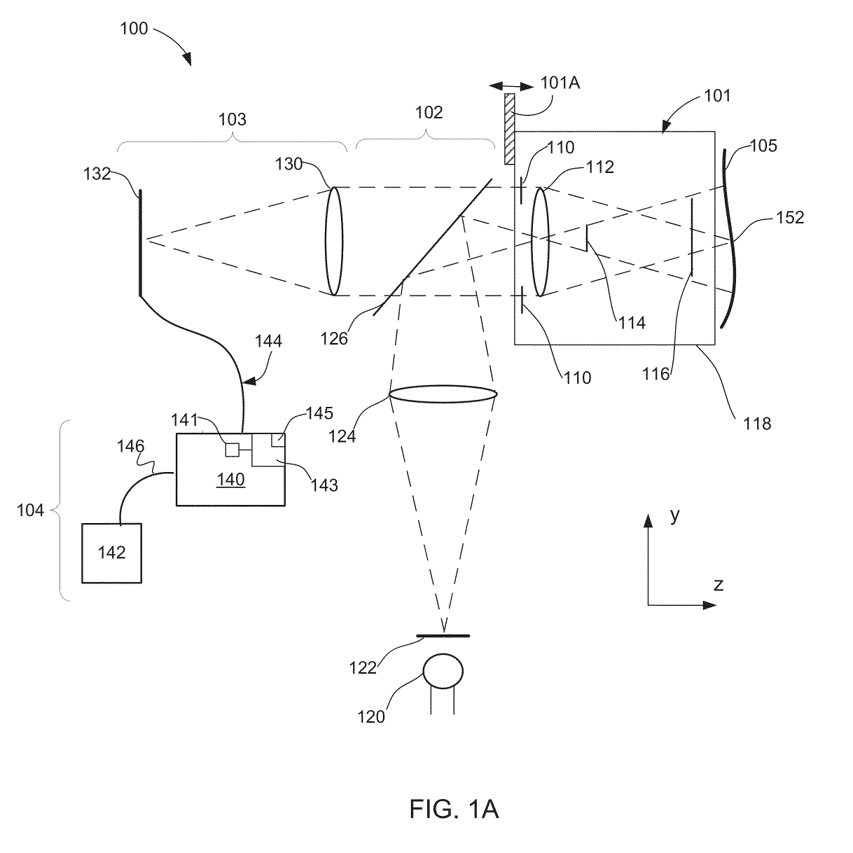

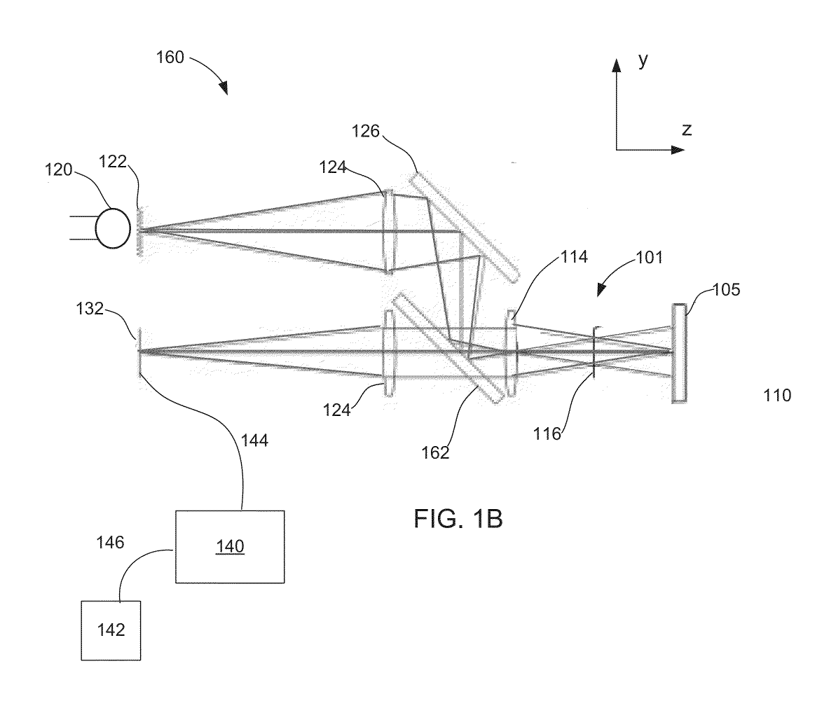

Examples of a System. A schematic diagram of an embodiment 100 of the invention is presented in FIG. 1A. The sensor 100 includes an objective sub-system 101, an illumination system 102, a detection system 103, and an analysis system (or data-processing unit) 104. Surface 105 is provided for illustrative purposes as an example of the surface under test (also referred herein as the measurand). The dashed lines of FIG. 1A represent the path(s) of light as it passes through the system 100 and is reflected from the surface 105.

The objective sub-system 101 is characterized by an entrance pupil 110, a focusing lens 112, a reference mirror 114, and a beamsplitter 116. In one embodiment, various components of the interference objective 101 are all housed separately from the rest of the sensor 100 (as shown —in a cell 118) to keep them permanently optically aligned with respect to each other. In the illustrative embodiment of FIG. 1A, the interference objective 101 is shown in a Mirau configuration, but generally, any other interference objective (such as, for example and without limitation, a Michelson or Linnick interference objective) may be used.

As shown in the specific example of the embodiment 100, the illumination system 102 is (preferably rigidly) attached to the interference objective 101 and includes a light source 120, a diffuser 122, a lens 124, and a beamsplitter 126. Here, the lens 124 is positioned to focus light emanating from the diffuser 122 through the beamsplitter 126 on to the entrance pupil 110 of the interference objective 101, to provide Kohler illumination for the interference objective 101. Generally, however, a different type of illumination (such as, for example, uniform illumination at the entrance pupil 110) can be used. The light source 120 is configured to emit quasi-monochromatic light at three wavelengths (corresponding, in a specific embodiment, to red, green, and blue portions of the visible spectrum). In one implementation, the light source 120 includes three operationally independent sources of quasi-monochromatic light the radiant outputs from which are spatially combined for delivery along the same optical path through the objective 101 towards the surface under test. In a related embodiment, the source 120 includes a source of spectrally broad-band light (for example, the source 120 may include a white-light LED) and a set of three spectrally-distinct optical filters defining spectrally-distinct throughputs when placed in front of the optical source 120. In a specific embodiment, the output from the light source 120 may include light at wavelengths of approximately 480 nm, 540 nm, and 635 nm.

The detection system 103 includes a focusing lens 130 and a color array detector 132. In one implementation, the color array detector 132 is a three-color array sensor. Alternatively, the color array detector 132 may include a color CCD (charged-coupled device), a CMOS (complementary metal-oxide semiconductor) device, or another color image sensor known in the art, operating without optical filter(s) that define spectral band(s) of light incident onto the detector 132.

The analysis/data-processing system 104 is in communication with the color array detector 132 via a communication link 144 and includes a computing device 140 equipped with a programmable processor 141 that is in operable communication with tangible, non-transitory computer-readable medium 143. The medium 143 has a computer program product (with a program code and instructions) 145 encoded thereon. In one implementation, the computing device 140 includes one or more of an application server, a web server, a work station, a host computer, or other like device from which information can be stored and/or processed. The computer readable medium 143 may include, for example, at least one of a magnetic information storage medium (such as a hard disk drive, floppy disk drive, or magnetic tape), an optical information storage medium (such as a Digital Versatile Disk, or DVD; a High-Definition DVD, or HD-DVD; a Blu-Ray Disk, or BD; a Magneto-optical (MO) disk, and a Phase-Change medium, to name just a few), and an electronic information storage medium (a device such as PROM, EPROM, EEPROM, Flash PROM, compactflash, and smartmedium).

The analysis system 104 may further include a display device 142, optionally in operable communication with a computing device 140 via a communication link 146. In certain embodiments, analysis system 104 may further comprise other peripheral devices in communication with computing device 140 such as, and without limitation, input devices, printers, and other computing devices. All in all, the data-processing system 104 is equipped with a sub-system enabled to generate a visually-perceivable representation of the results of operation of the data-processing system 104.

Alternatively or in addition, the analysis system 104 is further in operable communication with the equipment or machine (not shown) upon which sensor 100 is mounted (such as, for example, and without limitation, a diamond turning lathe). In a related implementation, the analysis system 104 is in communication with a separate moveable stage (not shown) attached to a machine, such as a diamond turning lathe, which moveable stage is configured to change the orientation and/or position of the sensor 100. The analysis/data-processing system 104 is structured to generate an output to be transmitted to the machine or a greater system which is used to define and/or maintain the position and/or orientation of the sensor 100 in space. Such output may include, for example, an electrical signal (such as, for example, a voltage pulse or a pulse of current) or a set of computer-readable instructions that cause the programmable processor 141 move the sensor 100. In a related implementation, the output may include data based on which the programmable processor 141 is programmed to calculate how to move the sensor 100.

While the computing device 104 is illustrated as being in communication with the color ray detector 132 and display 142 via the communication links 144 and 146, respectively, generally the computing device 104 may employ wireless communication means (such as, for example, means including source(s) and detector(s) of radio, microwave, and infrared waves).

In one implementation, the objective sub-system 101 may be configured to be repositionable by cooperating it with a piezoelectric actuator (PZT) 101A (shown with a dashed line) the operation of which is governed by the computing device 104, whether through an electric and/or data-transmitting cable or wirelessly.

In a specific implementation, the color array detector 132 is configured to produce an output that represents a distance between the interference objective 101 and the measurand 105 (for example, the output the value of which is proportional to such distance) and that is proportional to the dihedral angle formed by the reference mirror 114 of interference objective 101 and the measurand 105. The generated output is then analyzed by the computing device 104 with the use of instructions 145 to detect errors in the finish and/or contour of measurand 105.

Where the display device 142 is part of the system, the computing device 104 may be employed to generate an image of measurand 105. In such embodiments, all or at least a portion of the image of the measurand 105 may be displayed. In preferred embodiments, the displayed image corresponds to a portion of measurand 105 that is as large as the area of the detecting, photo-sensitive surface of the color array detector 132 divided by a coefficient substantially equal to the image magnification produced by the combination of the interference objective 101 and the detection system 103 (provided the objective 101 is well focused on the measurand 105).

In a related embodiment, the sensor of the invention has the configuration 160 illustrated in the schematic diagram of FIG. 1B. As can be seen in FIG. 1B, and in comparison with the embodiment 100, a second beamsplitter or mirror 162 is added to make the sensor 160 more compact then the sensor 100, while the light source 120 and the color detector 132 substantially remain in the same plane.

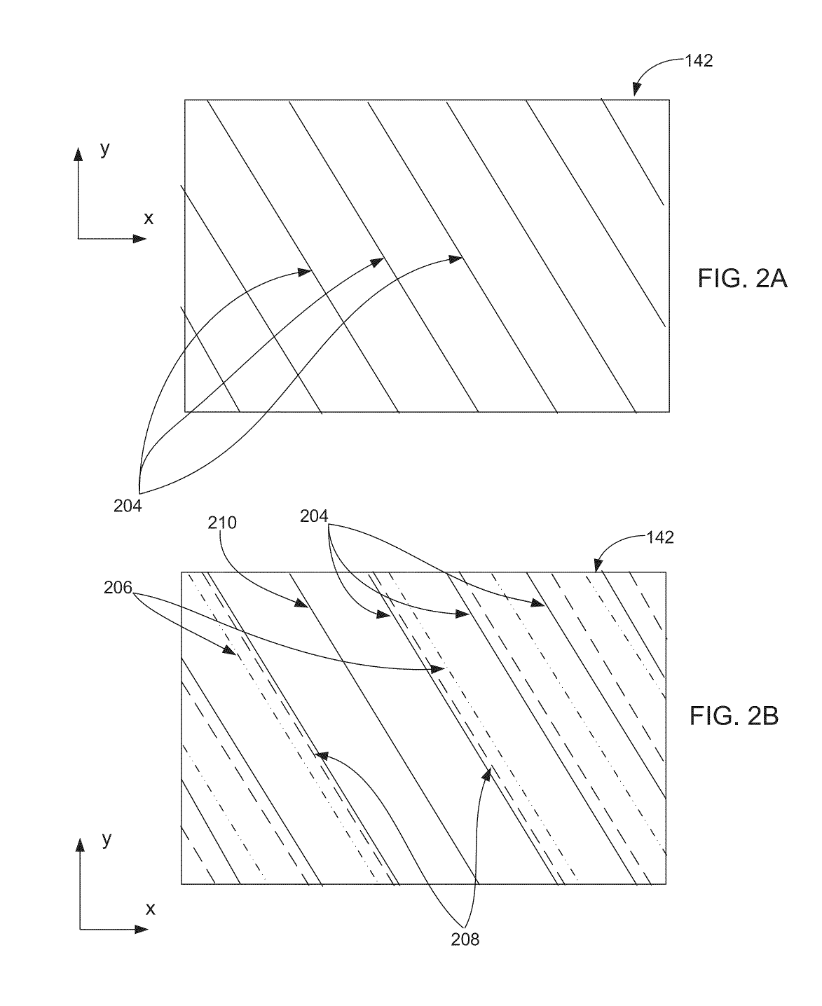

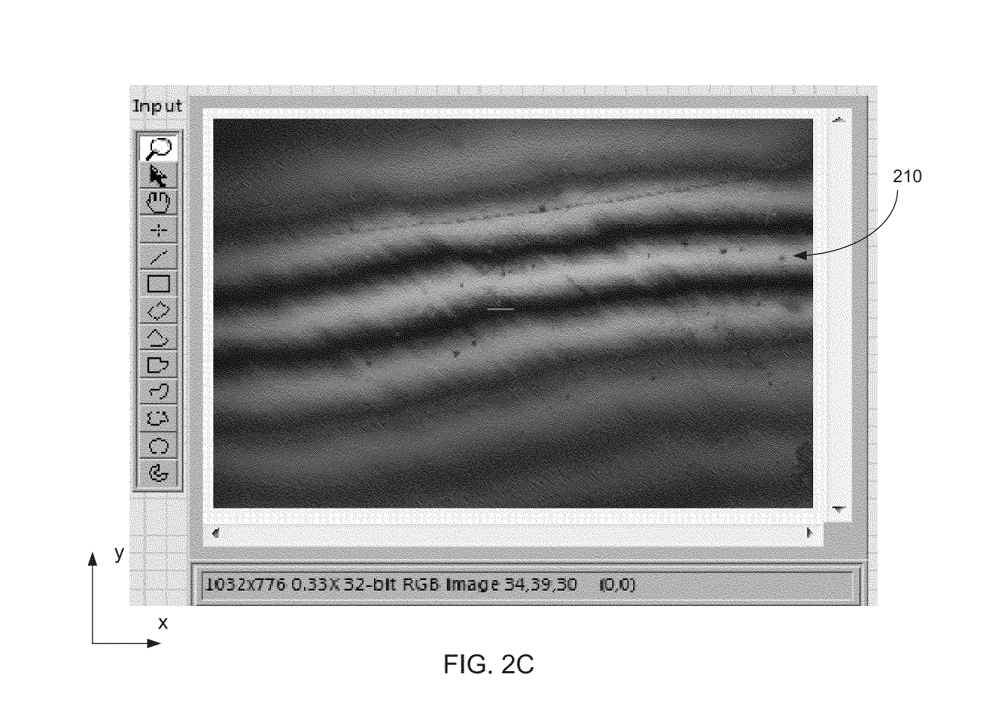

By way of example, if the light source 120 is replaced with a source of substantially monochromatic light, then when the objective 101 is focused on the measurand 105, the image of the measurand 105 on the video screen 142 would show a series of substantially straight and approximately equally-spaced interference fringes (such as fringes 204 illustrated in FIG. 2A). In such an embodiment, the spacing between the immediately adjacent fringes 204 is proportional to the angle between the reference mirror 114 and the area 152 (of the measurand 105) (which area 152 defines an optical conjugate of the detecting surface of the color array detector 132) and the wavelength of the light produced by light source 120.

Interferometric Output. The interference fringes resulting in a system of the invention that utilizes the light source 120 generating quasi-monochromatic light at three distinct wavelengths are shown schematically in FIG. 2B. In the present example, fringes 204 (shown in the solid line) are produced in light having the same wavelength as the fringes illustrated in FIG. 2A, assuming the angle between reference mirror 114 and area 152 on measurand 105 remains the same between FIGS. 2A and 2B. In the illustrated example of FIG. 2B, the fringes 204 are produced by light having the shortest wavelength of the three wavelengths (for example, the blue light). Fringes 208, represented by the dashed lines, are spaced further apart and represent the fringes produced by light at an intermediate wavelength (for example, green light), while fringes 206 (represented by the dash-and-dot lines) are those produced by light at the longest wavelength used (in this example—red light). An empirically acquired visually-perceivable colored representation of the fringes of FIG. 2B is shown in FIG. 2C

As is illustrated in FIG. 2B, all three sets of fringes produced by light at the three different wavelengths collapse into a single fringe 210 when the phases of corresponding portions of light at all three wavelengths are substantially the same. This common-phase fringe 210 is referred to herein as the “zero-order” fringe and represents the situation where the optical distance between the reference mirror 114 and the beamsplitter 116 is exactly the same as that between the beam splitter 116 and the conjugate point 152 on the measurand 105. Indeed, if zero-order fringe 210 were optically projected back onto measurand 105, each point of such projection would be at the same distance from the beamsplitter 116 as reference mirror 114. The unique character of the zero-order fringe 210 permits the absolute determination of the distance separating the objective sub-system from the measurand 105. As the position of the zero-order fringe 210, viewed on the video screen 142, changes with a change of the distance from the objective to measurand 105, such change provides a sign of change from a chosen initial/reference position of the fringe and thus provides a signed feedback measure of either the absolute distance between the objective and the measurand, or of how far and in which direction the sensor has to be moved to return the zero-order fringe 210 back to its initial/reference position on the video screen 142.

As can be seen in FIGS. 2B, 2C, since the fringe pattern produced by the light source 120 with light at the three wavelengths is substantially symmetric around the zero-order fringe 210, a reference mirror 114 of the sensor 100 (or, alternatively, the sensor 100 itself) is preferably inclined at a small angle α with respect to the surface under test of the measurand 105 in order to determine the nature of the change (increase or decrease) of the angle and to produce a feedback indicative of the way and/or direction in which the sensor 100 should be rotated to maintain the angle α. When the angle of inclination a is maintained, the number of interferometric fringes in the resulting pattern, which is related to the angle of inclination of the sensor 100 with respect to the measurand, is also maintained constant across the detector 132. (Generally, a greater number of fringes corresponds to a greater angle of inclination and a fewer number of fringes corresponds to a smaller angle of inclination. Indeed:

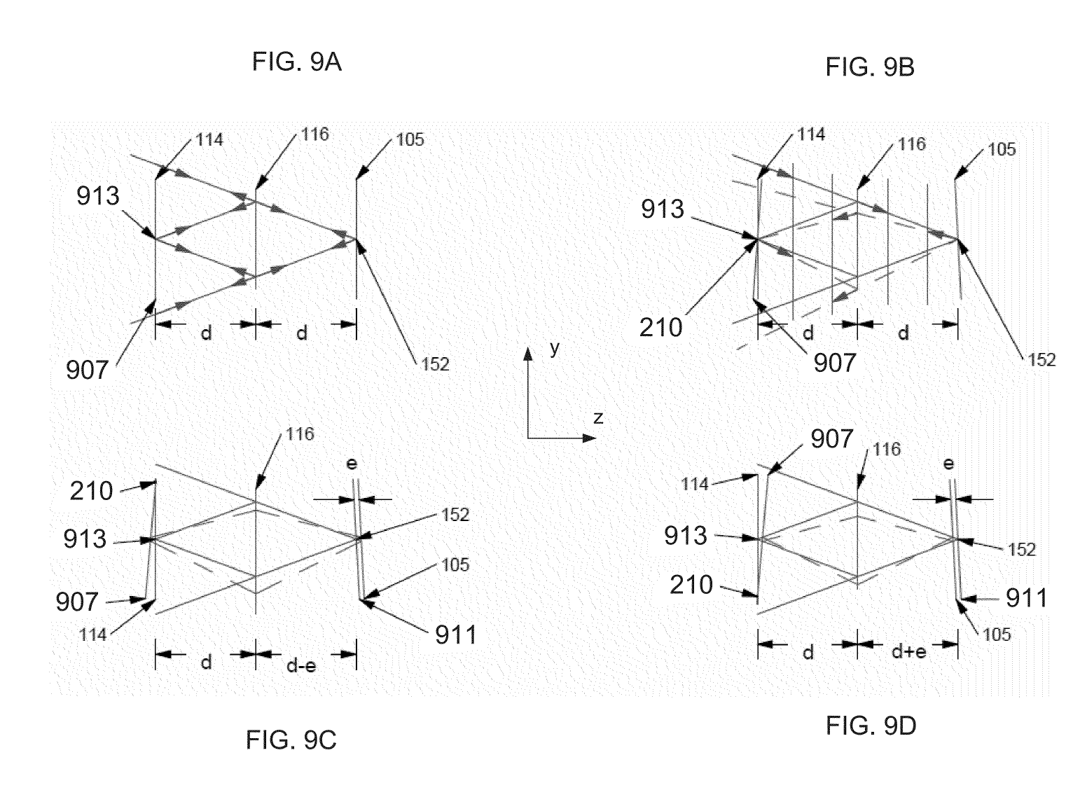

As can be seen in FIGS. 2B, 2C, since the fringe pattern produced by the light source 120 with light at the three wavelengths is substantially symmetric around the zero-order fringe 210. The following discussion is presented in reference to FIG. 1A and in further reference to FIGS. 9A through 9D (which show schematically a portion of the optical train of the embodiment 100 in side view). It is appreciated that the zero-order fringe 210 is formed (as a product of the interferometric fringes corresponding to the three wavelengths of the light source 120) under the condition that the measurand 105 and the reference mirror 114 of the objective 101 are separated from the beamsplitter 116 by exactly the same distance (as shown in FIG. 9A).

When the measurand 105 and the reference mirror 114 are perfectly parallel to one another, as shown in FIG. 9A, an image 907 of the measurand 105 substantially coincides with the reference mirror 114. As a result, the zero-order “white” fringe 210 extends across the full aperture of the reference mirror 114 (and, accordingly, across the full clear aperture of the detector 132). In practice, this “parallel orientation” condition is not very useful: a small angle should exist between the measurand 105 and reference mirror 114, and shown in FIG. 9B to make practical use of the embodiment of the invention.

When the surface of the measurand and the surface of the reference mirror form a non-zero dihedral angle with respect to one another, the zero order fringe 210 is localized in the middle portion of the reference mirror 114 (and, therefore, in the middle portion of the detector 132, as depicted in FIG. 2C, for example) and extends along an axis about which the measurand 105 is tilted relative to the reference mirror 114. (Such axis corresponds to the x-axis in the local system of coordinates associated with FIGS. 9A through 9D). The position 913 along the y-axis in the middle of the reference 114, corresponding to the location of the zero-order fringe 210 under these conditions, as the reference point (or “zero point”) for the following measurements and data analysis.

Because of the small angle α between the measurand 105 and the reference mirror 114, a set of interferometric fringes at each of the three wavelengths of the light source 132 will be formed at the detector 132 of the embodiment 100, creating a zero-order fringe 210 at the area corresponding to optical path lengths equal at all three wavelength. The number of the interferometric fringes across the clear aperture of the detector 132 depends on the tilt angle α. Indeed, the width of the interferometric picture is tilt-angle dependent according to

y=λ/2*tan(α), (1)

where y is the space between fringes along the y-axis, and λ is the wavelength of the light producing the set of fringes. The axial sensitivity of measuring the displacement between the embodiment of the sensor and the object under test can be determined based on the Eq.(1). As the wavelength of light increases, the spacing of the fringes increases as shown in FIGS. 2B, 3 and 4, as well as increasing when the angle α decreases.

If the distance d between the measurand 105 and the reference mirror 114 changes (in comparison to that between the beamsplitter 116 and the reference mirror 114), the position of the zero-order fringe 210 changes in the xy-plane, as shown in FIGS. 9C, 9D. With the fixed angle of α, a decrease in the distance d by e causes the zero-order fringe 210 to move upwards (along the y-axis, as indicated by a new location of the point 210 in FIG. 9C). An increase of the distance d by e results in the shift of the zero-order fringe 210 and in the opposite direction (see the shift of the points 210 in the -y direction, FIG. 9C). The distance Δy by which the zero-order fringe 210 shifts vertically, along the y-axis, is

Δy=e/tan(α), (2)

which is the distance separating points 913 and 210 in FIGS. 9C and 9D. As the transverse shift of the zero-order fringe is proportional to e, and inversely proportional to a, the sensitivity of the fringe motion to tilt between the measurand and the reference mirror is higher for small angles a and lower for larger angles. Therefore, an embodiment of the sensor of the invention is characterized by variable sensitivity of measuring a displacement along an axis of the interference objective, which can be adjusted simply by re-alignment of the sensor of the invention with respect to the measurand.

As the change of the distance e between the measurand 105 and the reference mirror 114 is not the same across the measurand 105 (i.e., it is not the same for every point of the measurand's surface) due to the measurand's curvature and the roughness of its surface, the separation Δy of locations of the zero-order fringe (point 210) and point 913 in FIGS. 9A . . . 9D along the local y-axis varies. Whatever the zero-order fringe location 210 may be relative to the reference zero 913 for a given point at the surface of the measurand, the Δy value provides a measure of the change in distance to that given point of the measurand based on Eqs. (1) and (2), resulting in

eᵢ=yᵢ*tan(α) (3)

where i is the index of the columns along the x-direction in FIG. 2C in the x-direction. According to an embodiment of the invention, by fitting the values of eᵢ a straight line (with, for example, a least-square method) a measure of the curvature and roughness of the measurand (at the particular measurand's point 152 that is being imaged at the moment) is obtained. This measurement can be made at the frame rate of the camera and computer system to which it is attached. Thus, a contour line (the low order fit to the zero-order fringe locations) and roughness (the rms of the eᵢ locations from the linear fit line) measurements can be made in real time as the sensor is scanned past the measurand or measurand scanned past the sensor as would be the case if used as a non-contact sensor on a roundness measuring station.

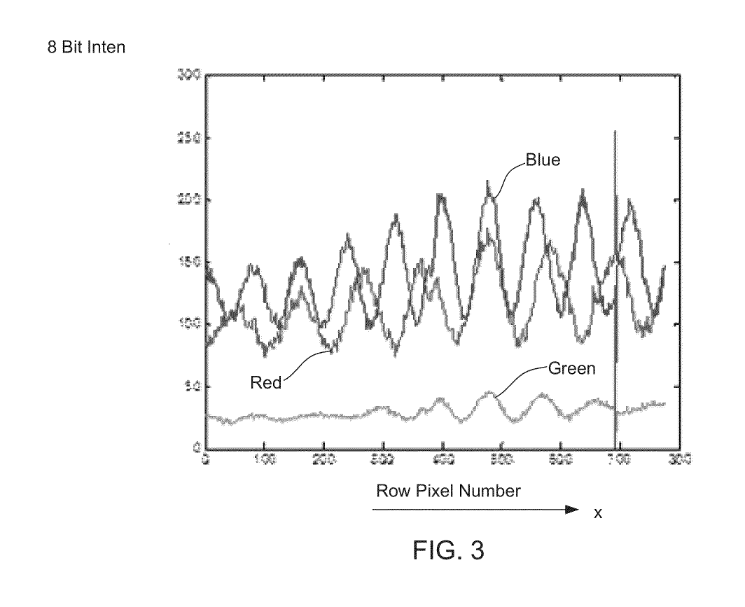

By separating the sub-sets of data, acquired at the detector 132 and corresponding to the red, blue, and green light, the profiles of irradiance represented by such sub-sets of data appear similar to those empirically acquired and depicted in FIG. 3. As can be seen in FIG. 3, the phases of all three intensity profiles are aligned at pixel 481, representing the zero-order fringe 210 of FIGS. 2B, 2C. The spike at pixel 694 is due to a scale bar. In FIG. 3, the curves of raw data sets (Red, Green, Blue) have been detrended, which included setting the mean value of each distribution to zero and removing any overall tilt from the irradiance pattern (by using, for example, a least-square method to fit the data points to a straight line). Thus, the acquired irradiance data underwent the following transformation:

Irradiance_{(new)}=A+B*Irradiance_{(old)} (4)

where the coefficients A, B are defined to ensure the zero mean and no tilt.

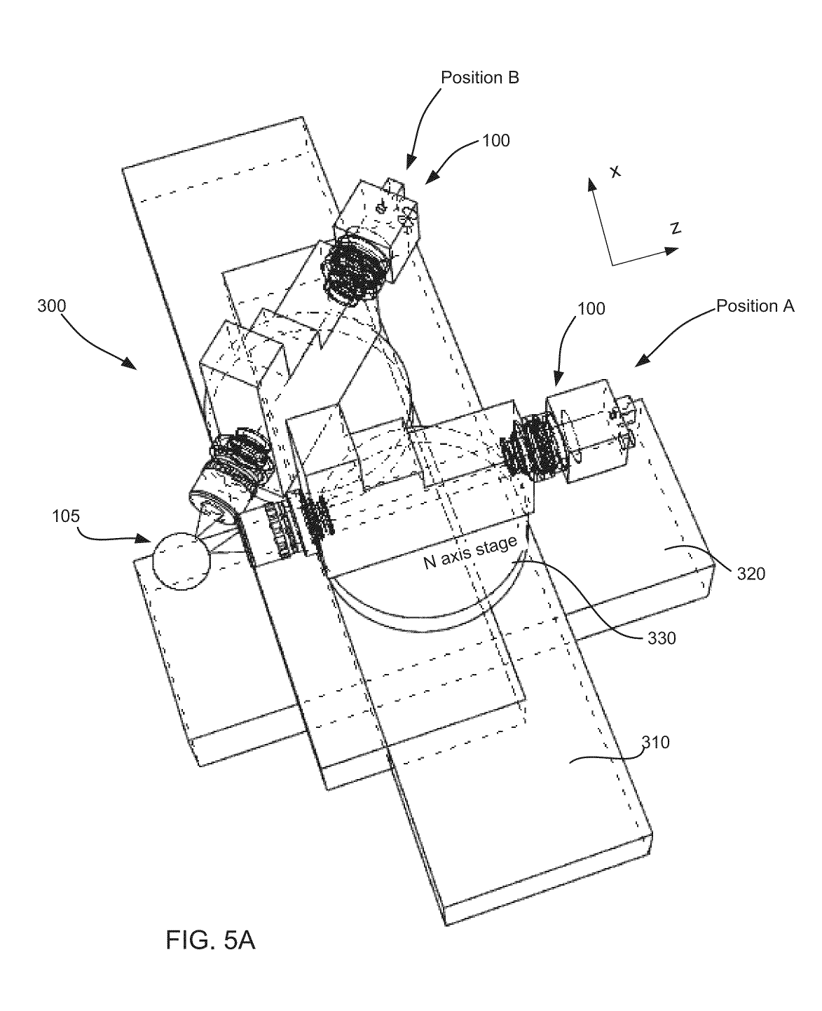

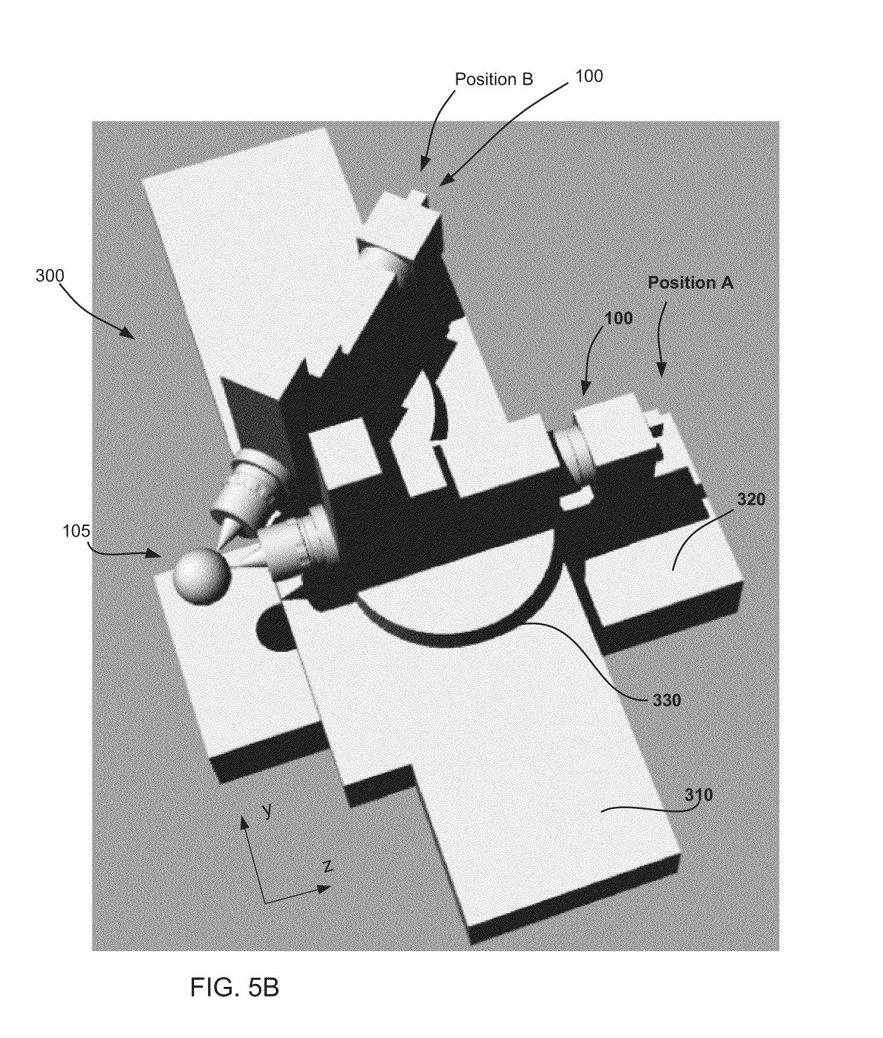

In certain embodiments, the sensor 100 (and/or the sensor 160) is mounted on a movable stage, such as stage 300 shown in wire-frame view in FIG. 5A, having both an X axis stage 310 (enabling the repositioning along the x-axis) and a Z axis stage 320 (enabling the repositioning along the z-axis) as well as a rotary stage 330 (enabling the repositioning in the azimuthal plane, referred to as the N axis). The stage 300 may optionally include a piezo-electric device positioned, for example, between the elements 100 and 101. In this case, only the objective of the sensor can be moved with respect to the measurand instead of the sensor as a whole. As can be seen, FIG. 5A illustrates the sensor 100 in two different positions, position A and position B, to illustrate that the sensor 100 can be moved and/or repositioned along the X, Z, and N axes. FIG. 5B provides a light-and-shadow rendering of the stage 300.

In operation, the stage 300 is mounted on the diamond turning machine. As will be appreciated by one of ordinary skill in the art, the means for mounting of the stage 300 on the machine depends on the particular diamond turning machine and requires only routine skill. Furthermore, one of ordinary skill in the art will appreciate that stage 300 is meant to be illustrative and not limiting and that other stages having other configurations that would allow the sensor 100 to move in the Z, X, and N directions are also within the scope of the present invention.

In a specific case when stages 310 and 320 are already a part of the diamond turning machine, the embodiments of the sensor could be mounted directly to these stages and used to scan parts if they are planar or substantially planar. If the parts are substantially curved, then the N axis stage must be used to keep the sensor oriented perpendicularly to the part.

In the preferred embodiment, however, the sensor 100 of FIG. 1A (or the sensor 160 of FIG. 1B) employs the structure of a diamond turning machine or another milling device that enables the movement in the X and Y directions to position itself relative to the measurand. In such a case, the sensor 100 may be provided only with an N-axis stage, the X and Z axis stages being optional. By utilizing the movement of a device upon which the sensor is mounted, rather than using a separate stage, the present system can be manufactured at a far lower cost.

Whether the stage 300 is employed or the movement of the diamond turning machine is used, the sensor 100 is preferably centered on the rotary stage to minimize the overhung moments, as illustrated in FIGS. 5A, 5B. In other embodiments however, the sensor 100 may be mounted differently depending on the size and shape of the measurand.

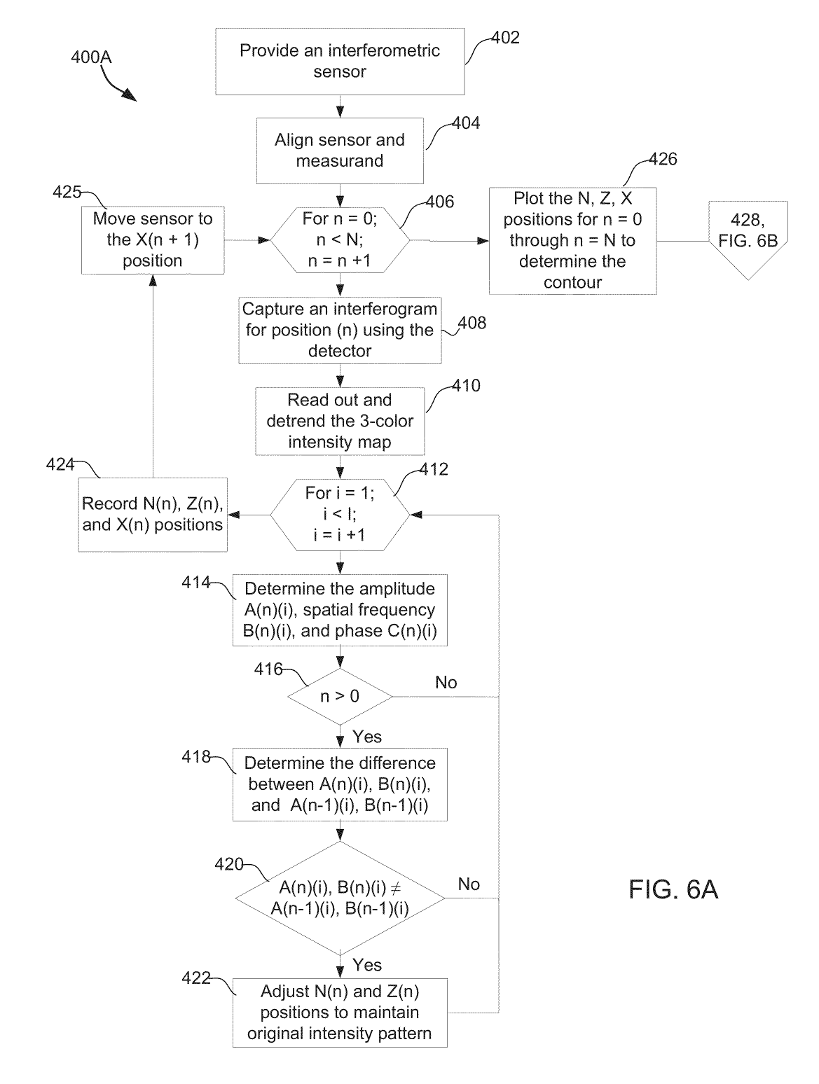

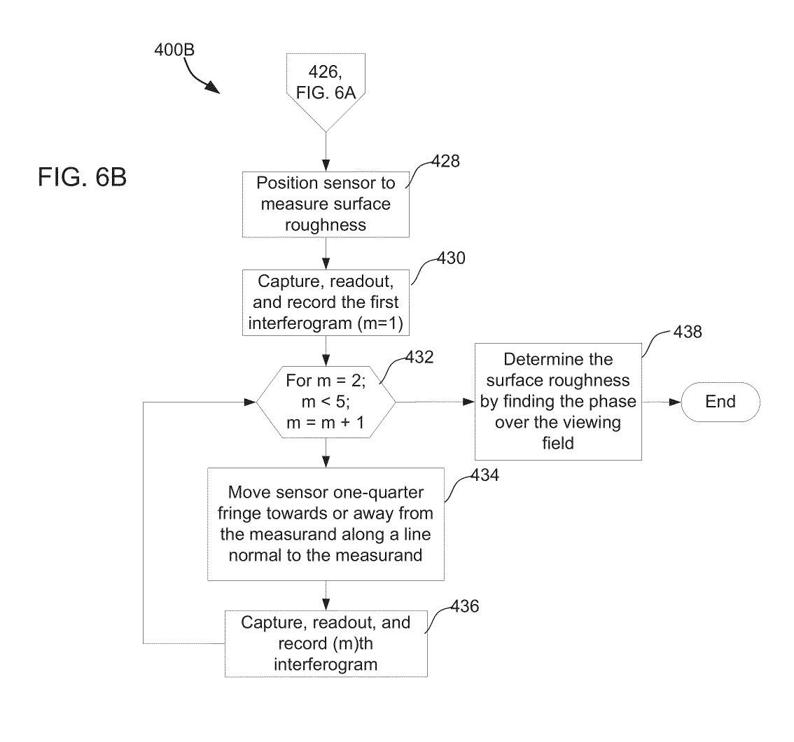

Example of Algorithm. Turning now to FIGS. 6A and 6B, an example of the method of the invention is depicted with the flow-charts 400A, 400B. An embodiment of the method can be used to determine the contour and surface roughness of the measurand with the use of the embodiment of the sensor of the invention. At step 402, the sensor is provided mounted directly on the diamond turning machine and/or on a separate stage that enables movements along the X, Z, and N axes. The sensor is in communication with a computer processor, which both receives the data captured by the sensor and communicates with the diamond turning machine and/or the stage to position the sensor relative to the measurand. In certain embodiments, the computer processor is further in communication with a visual display device.

With respect to FIG. 6A, and as is indicated by step 404, the sensor is first aligned with the measurand. In the aligned position, the focus of the objective is on the vertex of the measurand, that is, for a diamond turning machine geometry, centered on the Z axis, wherein the Z axis stage (stage 320, FIGS. 5A, 5B) is adjusted so the zero-order fringe is in the middle of the detector frame. Optimally the tilt is such that there are 8-10 fringes across the field, though this is not a requirement and the present method can be used when there are more or less fringes. Where a visual display device is being used, the field can be displayed such that the position of the zero-order fringe and total number of fringes can be visually verified. In other embodiments, the position of the zero-order fringe and total number of fringes is determined by the computer processor.

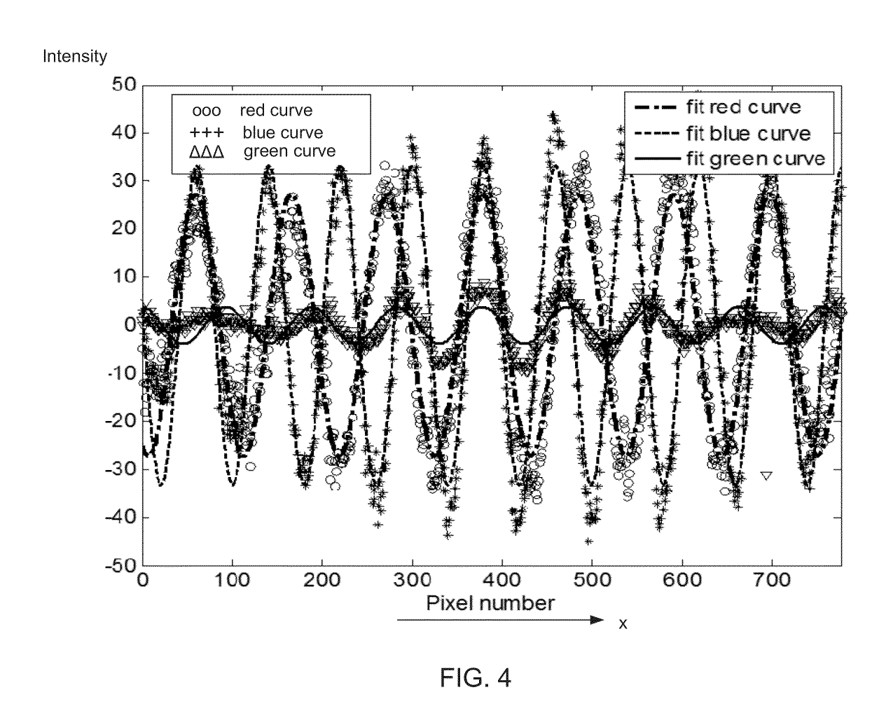

As is indicated by steps 406, 408 and 410, the sensor's 3-color detector is used to capture interferogram at position (n) and to readout and detrend the same to make the intensities lie about their mean on a line free of tilt, such as is illustrated in FIG. 4.

As is illustrated in FIG. 6A, for each position (n), the amplitude (A)(n)(i), spatial frequency B(n)(i), and phase C(n)(i) of the waveform can then be determined by applying a non-linear least squares fitting algorithm separately to each of the three sets of data (received, respectively, at the three distinct wavelengths such as RGB), as is indicated by blocks 412 and 414. The non-linear least squares fitting algorithm has the form:

y=A*sin(B*x+C). (5)

FIG. 4 provides an example of the detrended raw intensity data as symbols and the fit data as lines. While the amplitudes of the three intensity plots are unimportant for the present analysis, the spatial frequency B and phase C are used to determine the contour. The spatial frequency B is proportional to the number of fringes across the field of view and the tilt between the mirror in the objective and the measurand. The phase C is used to initially find the zero-order fringe and to keep track of its position in the field of view of the detector as the zero-order fringe position in the field of view is a measure of the distance to the measurand.

Alternatively or in addition, and in a related embodiment, the zero-order fringe of an interferometric pattern produced by the detector 132 can be identified by forming a product of the three sets of data acquired from the detector (which sets respectively correspond to light received by the detector at the three distinct wavelengths) and finding the extrema of the distribution of this product across the surface of the detector. This can be done on a column-by-column basis or on a row-by-row basis (i.e., for each linear arrangement of pixels across the detector).

In further reference to FIG. 6A, as indicated by step 416, where the sensor is in the initial position (i.e., n=0) the method moves to block 424 once the non-linear least squares fitting algorithm has been applied to the intensity plot for each color (i), and the initial position of the sensor (N(0), Z(0), and X(0)) is recorded. The sensor moves to the X(n+1) position and the processes indicated by blocks 406, 408, 410, 412, and 414 are repeated.

For each color (i), once the amplitude, spatial frequency, and phase are determined, the differences between the current values for the spatial frequency and phase (B(n)(i), C(n)(i)) and the original values (B(0)(i), C(0)(i)) are determined, as indicated by steps 416, and 418. As will be appreciated, as the sensor is moved outwardly along the X-axis, either using a preprogrammed trajectory or by receiving instruction from an operator, both the distance to the objective and the angle between the objective and the measurand will change slightly. The difference between B(n)(i), and C(n)(i)) and the original values (B(0)(i), C(0)(i)) can be used as feedback to the Z and N axis of the sensor stage to restore the original alignment conditions even though the sensor is in a new position along the X axis. Thus, once the difference is calculated, the sensor's position along the Z and N axes is adjusted to restore the original intensity pattern, as is indicated by step 422.

Once the process represented by steps 414-422 has been repeated for each color (i) (i.e., i=1), the N(n), Z(n), and X(n) positions are recorded. The sensor is then moved to the next X position (i.e., X(n+1)) and the process repeated until the sensor has scanned across the measurand. The N, Z, and X positions for n=0 through n=N can then be plotted, wherein the plot represents a contour that is strictly proportional to the contour of the measurand. The constant of proportionality is determined by the distance between the sensor zero-order fringe position and the point about which the sensor is rotated in N. In certain embodiments this distance is pre-calibrated before the sensor is used.

The measurement process has been described above in reference to a rotationally symmetric measurand. However it can also be applied with minor variation where the measurand is non-rotationally symmetric. In such situations, if the asymmetry is small (for example, it has a slope variation in azimuth of roughly 10 minutes or less) the stage illustrated in FIGS. 5A, 5B can be used without modification. As the measurand rotates on the diamond turning spindle, the number of horizontal fringes will vary. The non-linear least squares fitting algorithm can be applied to calculate the B and C coefficients for horizontal fringes as a function of azimuth for a fixed X axis position. While there will be no feedback, the coefficients themselves will be the measure of the slope and distance from objective to the measurand as a function of azimuth.

For larger slopes, the stage illustrated in FIGS. 5A, 5B can be modified to include a translation along the y-axis (Y-translation) and a rotation of the sensor in a plane of inclination (referred to as an M rotation axis) so that the sensor could remain relatively normal to the surface of the measurand. The coefficients would then be calculated vertically as well as horizontally so that there would be feedback in the N, Z, Y, and M axes to keep the sensor normal to the measurand. The Z axis position would be the same for both horizontal and vertical components of the fringes. The rate of rotation of the spindle is optimally controlled since the slope changes as a function of azimuth will be larger toward the edge of the measurand than in the center.

While the movement of the sensor in X is described in FIG. 6A as being incremental, one of ordinary skill in the art will appreciate that such a description has been given for clarity of illustrating the method depicted with the flow-chart 400A and is not intended to be limiting. In other embodiments the sensor moves at a constant speed.

In one example, the process described in reference to the flow-chart of FIG. 6A can be used to characterize an object under test rotating at a constant speed about an axis that is different from the optical axis of the objective of the sensor. Such characterization can be carried out, for example, with a one-megapixel camera having a 10× objective operating at magnification of about 5 and a detector having a lateral extent, along the x-axis, of about 5 mm. In this example, the camera video rate is 30 frames per second. It is appreciated that the extent of the FOV of the sensor at the surface of the object under test in x-direction is about 1 mm. During the rotation of the object, the FOV of the detector would circumscribe, on the surface of the object, a closed band that is about 1 mm in width in about 2 seconds and collect the data characterizing roughness of such band-defined portion of the object's surface with a spatial resolution of about 1 micron.

Turning now to FIG. 6B, the flow-chart 400B of FIG. 6B illustrates a portion of the process of the invention describing a measurement of the object under test that can be carried out independently from, alternatively to, or in addition to that illustrated in reference to FIG. 6A. Although, as presented in the flow-chart 400B, the surface roughness is calculated after the contour of the surface under test has been determined, generally the measurement of the surface roughness can be effectuated at any point on the measurand and before or during the process for determining the surface contour. For example, if the sensor has been previously used to carry out the measurements according to FIG. 6A, the sensor is already positioned correctly at any point along the scan (that is, substantially along a line normal to the measurand's surface at a chosen point) and focused on the surface of the measurand. An extension of the process of FIG. 6A is to carry out measurements needed to determine a map of the surface roughness at a chosen location on the surface of the measurand, which can now be effectuated by ceasing the relative motion along the x-axis between the sensor and the measurand (by, for example, stopping the rotation of the object under test), as indicated by step 428. For purposes of illustration, the first interferogram is referred in method 400 as Interferogram (m=1).

Once the sensor is positioned, the first intensity map is captured, read out, and recorded, as indicated by step 430. Next, using a combination of X and Z motion to move the sensor (away from or towards the measurand along a line normal to the surface under test) by a distance corresponding to one-quarter of an interferometric fringe, a series of three more interferograms are captured, read out, and recorded at each position, as indicated by steps 432, 434, and 436. Since the sensor was initially positioned at an angle N with respect to the normal to the surface of the measurand, the ratio of the extent of the X motion to that of the Z motion is represented by tan(N):

$$[ \frac{X}{Z} ] = tan ( N ) .$$

The total extent of the motion of the sensor corresponding to a change between the acquired interferograms is substantially 480 nm for the blue light divided in half for reflection and the further by one-quarter for the one-quarter fringe, or about 60 nm.

Once all four maps of irradiance are taken, the surface roughness can be determined by using any one of a number of known algorithms, the most common of which is the so-called 4-bucket algorithm. The 4-bucket algorithm will be well known and within the skill of one of ordinary skill in the art. However, among other sources, the phase shifting algorithms for surface roughness and contouring in general are discussed in D. Malacara, Optical Shop Testing, Ch. 14-15 (3rd ed., Wiley 2007).

More specifically, as is indicated by step 438, the surface roughness is calculated by finding the phase θ over the entire viewing field of the objective (i.e. at every pixel) for the blue intensity curve, using:

$$θ = {tan}^{- 1} [ \frac{I ( m + 4 ) - I ( m + 2 )}{I ( m + 1 ) - I ( m + 3 )} ]$$

where I is the intensity of the pixel from the m^{th} interferogram. The phase is unwrapped, meaning that the 2*Pi steps are removed, and then the mean and tilt are removed in the phase map. At this point, the RMS (root mean-square) phase over all the pixels is the RMS surface roughness. In certain embodiments, the surface roughness is determined on the sub-nanometer scale.

Using the example of a one megapixel camera and a 10× objective operating, in an embodiment of the sensor, at approximately 5× magnification, as described above, at the end of the process 400B of FIG. 6B the data processing unit of the embodiment collects an array of about 1 megapixels of 3D contour and roughness data over a patch of the surface of the measurand that has about 1 mm on the side.

In certain embodiments, only one fringe pattern (that corresponding to light at a blue wavelength) is used because it is of about the same intensity as the red but has a shorter wavelength, thereby having approximately 30% (thirty-percent) greater sensitivity. Also, the red and green fringe patterns would corrupt the phase calculation.

While in the described embodiment 400 of the method the sensor is moved in steps corresponding to a quarter of the interferometric fringe to produce four fringe (irradiance) maps that are used to calculate the phase, in a related embodiment more or fewer than four interferograms may be captured. Further, while in the preferred embodiments the diamond turning machine is used to move the sensor toward the measurand, in other embodiments, a separate stage is used with the sensor to move the sensor towards the measurand. As will be readily apparent to one of ordinary skill in the art, the benefits of using the machine upon which the sensor is mounted to move the sensor, as opposed to a separate piezo-electric device attached to the sensor, is that it is a far more inexpensive way to measure contour and surface roughness.

It should be pointed out that since there is the ability to obtain both contour along a diameter and roughness on either side of the diameter, a complete mapping of the band of the surface of the measurand about the diameter is possible. In certain embodiments, the mapping may be performed at a resolution of about 1 μm spatially in both directions.

Program code(s), such as that containing instructions 141 (FIG. 1A) is encoded in non-transitory computer readable medium 143 (FIG. 1A), wherein those instructions are executed by processor 141 (FIG. 1A) to perform one or more of blocks 402-438 recited in FIGS. 6A and 6B.

An embodiment of the invention may include an article of manufacture containing a programmed processor governed with computer-readable instructions executed by a computer external to, or internal to, a computing system to perform one or more of blocks 402-438 recited in FIGS. 6A and 6B.

Additional Considerations. As follow from the discussion provided in reference to FIGS. 9A through 9D, embodiments of the present invention produce an unexpected result. More specifically, the embodiments enable an immediate determination of a figure-of-merit describing at least a one-dimensional (1D) and, optionally, 2D distribution of roughness across a surface under test based on interferometric data representing the product of the three interferograms acquired at the three wavelengths of operation of the source of light 120 of the embodiment 100 (or the embodiment 160).

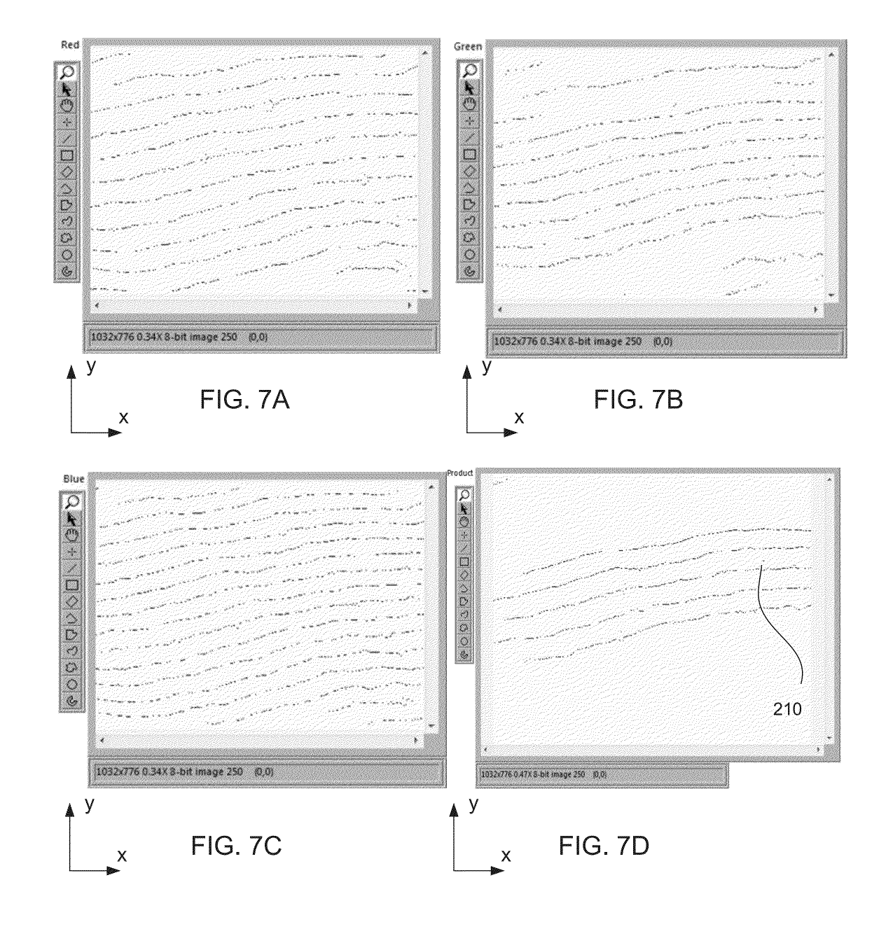

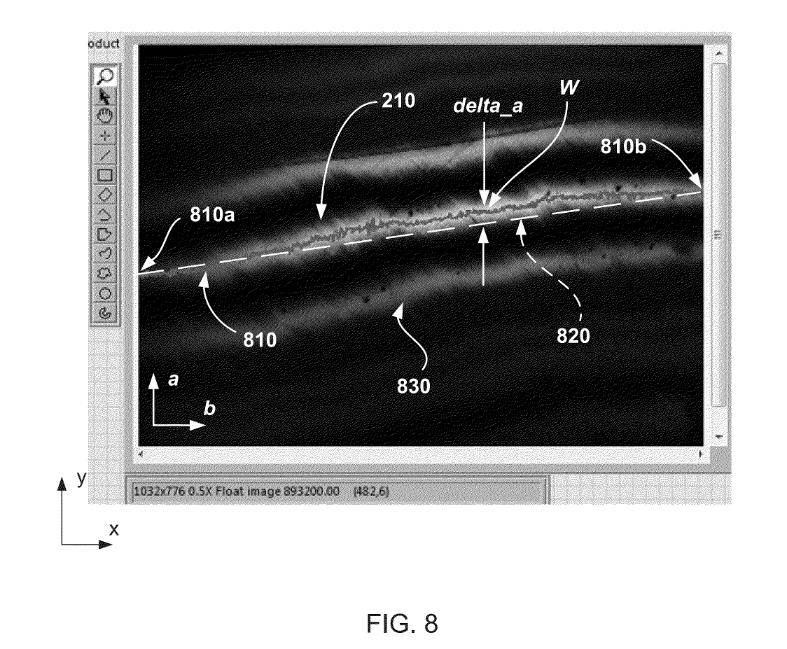

Referring now to FIGS. 7A through 7D and FIG. 8, FIG. 7A depicts an interferogram empirically obtained with an embodiment of the system of the invention during the measurement of a sample having an approximately 50 nm rms roughness in blue light generated by the three-wavelength source of light 120. FIG. 7B depicts an interferogram empirically obtained with an embodiment of the system of the invention during the measurement of the surface curvature of the same sample in green light generated by the three-wavelength source of light 120, while the interferogram of FIG. 7C is that acquired in red light. FIG. 7D presents a plot representing areal distribution of the product of irradiance values corresponding to FIGS. 7A, 7B, and 7C and, therefore, corresponding to the interferogram similar to that of FIG. 2C. A black-and-white version of the empirically acquired interferogram of FIG. 7D is shown in FIG. 8, with the marked zero-order fringe 210 and a red-line 810 overlapped onto the zero-order fringe 210 substantially along its crest. Each point of the line 810 corresponds to the center of the zero-order fringe 210 determined, with the processor of the system, in a slice of the interferogram along the axis a of the local system of coordinates a, b defined with respect to the interferogram and shown in FIG. 8. The deviation of the zero-order fringe 210 from the straight fringe is due to the local roughness of the surface under test. Accordingly, a set of values representing deviations, along the a-axis, of the points comprising the center line 810 from a reference line associated with the zero-order fringe 210 is a direct measure of the roughness of the surface under test at the locations corresponding to such points. As a matter of example, if the reference line 820 (shown as a dashed line) associated with the detrended zero-order fringe 210 is defined by the first and last points I, II of the center curve 810, then the values representing the separations between the lines 810 and 820 at each point (such as that denoted “delta_a” in FIG. 8) describe the distribution of the local roughness of the surface under test in the direction of the a-axis along the line 820.

In further reference to FIGS. 2, 8, and 9A through 9D, it is appreciated that the sensitivity of the measurement of roughness and/or curvature of the measurand at a given point 152 (that is being measured at a given instance of time) can be practically increased by reducing the tilt angle α (or, stated differently, mutually reorienting the measurand 105 and the sensor 100 to reduce the angle between the optical axis of the sensor 100 and the normal to the measurand's surface) to such an angle that causes the zero-order fringe 210, which is maintained substantially centered within the clear aperture of the detector 132, occupy substantially the most of such clear aperture. It would be appreciated, in reference to FIG. 8, that in this case the sensitivity of roughness measurement based on analysis of delta a can be maximized. Indeed, considering that the overall interferometric image of FIG. 8 is formed as a product of irradiance distributions of FIGS. 7A, 7B, and 7D at the red (about 632 nm), green (about 540 nm), and blue (about 480 nm) wavelength, the distance between the zero-order fringe 210 and a maximum of the immediately adjacent fringe (for example, fringe 830) is one half of the longest present wavelength, or about 316 nm. If the detector 132 contains 776 pixels in the y-direction, then the separation between the fringe maxima is about 160 pixels. Therefore, the angle formed by the reference mirror 114 and the measurand 105 that corresponds to the experimental results of FIG. 8 is about 316 nm per 160 pixels or about 1.98 nm/pixel. (The value of delta a at point W is about 24 pixels, which corresponds to about 48 nm. When all the differences are calculated in the x direction for all 1032 columns of data, the rms roughness of the area of the object corresponding to the FOV of the detector is found to be about 22.5 nm, or about 1 microinch.) If, however, the tilt angle α is reduced, for example, such that the separation between the maximum of the centered-in-the-FOV of the detector the zero-fringe 210 and the maximum of the immediately adjacent fringe 830 is approximately half of the FOV of the detector 132 (or, about 683 pixels), then the same 48 nm of delta_a separation at the point W would correspond to about 683 pixels and, therefore, the average sensitivity of the determination of the rms roughness would increase (as compared to the previous example) by at least 25 times.

It is worth noting that both the hardware and methodology of optical testing effectuated by an embodiment of the present invention significantly differs from that known as white-light interferornetry or modality. In applications employing white-light techniques (WLTs)), a monochromatic camera is used without the hardware differentiation of any particular color. The coherence function (represented by a fringe visibility envelope of the acquired interferometric data) is typically fit to the data, based on which the peak of the interferometric fringe distribution is located. When the white-light interferometer is correctly aligned, the location of the peak is in focus and the height of the peak is known (because the scan height is known). The surface of the object under test is scanned until all points within the field of view are mapped out.

In contradistinction with the WLTs, an implementation of the proposed method requires, a color-sensitive imaging system (for example, a system distinguishing among the three wavelengths such as RGB wavelengths) is used. The three color channels of the imaging system of the embodiment 100, for example, are equivalent to using color filters for wavelength separation at the surface of the detector 132. The data corresponding to these three color channels are easily stored together separately or in a single color image and are easily separable for subsequent processing.

In addition, the data processing required by the present invention involves separating the three channels (RGB) and them multiplying than together (as discussed above, for example in reference to FIGS. 2C, 8, and 9A through 9D). This multiplication process enhances the interferometric peaks (corresponding to the optical path lengths that are equal at all of the three wavelengths of the light source 120), and provides more definition visually and computationally. In stark contradistinction with the idea of the proposed invention, the WLTs essentially add the data acquired at multiple wavelengths other words, the white light image substantially corresponding to the summation of monochromatic images.)

Moreover, a map of height of the surface under test can be built up, according to an embodiment of the invention, by thresholding the resulting image as the test object is scanned. The WLTs do not involve thresholding of acquired data and often require complex fitting techniques to find the visibility envelope peak. At least for the reasons discussed above, a typical white-light interferometric system is simply not operable for the purpose intended by an embodiment of the present invention. At least for the same reasons, the adaptation of a typical white-light interferometric system for the purpose of the present invention would require hardware and/or data-processing modifications that would change the principle of operation of the white-light interferometric system.

While the preferred embodiments of the present invention have been illustrated in detail, it should be apparent that modifications and adaptations to those embodiments may occur to one skilled in the art without departing from the scope of the present invention.

What is claimed is:

1. A non-contact interferometric sensor for optical testing of an object, the sensor comprising:
an interference objective having an optical axis;
an optical detection system positioned to receive light transmitted through the interference objective, wherein the received light is characterized by three distinct wavelengths; and
a data-processing unit containing a programmable processor and tangible, non-transitory computer-readable medium with computer-readable product contained thereon, the computer program product containing program code that, when loaded onto the processor, enables the data-processing unit to
acquire, independently from one another, three sets of data from the optical detection system, said sets respectively representing interferometric light distributions formed in light transmitted through the interference objective at respectively corresponding distinct wavelengths; and
form a product of the three sets of data to produce sensor data.

2. A sensor according to claim 1, further comprising an illumination system including a source of light delivering light at said three distinct wavelengths along the optical axis.

3. A sensor according to claim 2, wherein the illumination system and the interference objective are configured to provide Kohler illumination in light transmitted through the objective.

4. A sensor according to claim 1, further comprising a set of three optical filters disposed across a beam of light transmitted through the interference objective to defined said three distinct wavelengths.

5. A sensor according to claim 1, further comprising a means for varying an angular orientation of the optical axis with respect to a reference line, said varying an angular orientation enabling a change of a sensitivity of the sensor to measuring a distance along the axis.

6. A sensor according to claim 1,
wherein said sensor data includes data representing a portion of the interferometric light distributions that corresponds to first, second, and third portions of light, transmitted through the interference objective at the respectively corresponding distinct wavelengths from the three distinct wavelengths, that have traversed substantially equal optical paths; and
wherein the program code further enables the data-processing unit to determine a curvature and roughness of a surface of the object under test illuminated with light transmitted through the interference objective.

7. A method for optically determining a descriptor of a surface of an object, the method comprising:
receiving, with an optical detector, light that has been reflected by the object and that has traversed an interference objective having an axis, the received light characterized by three distinct wavelengths;
acquiring, with a programmable processor, first, second, and third data from the optical detector, wherein said first, second, and third optical data represent interferometric images of the object formed in light at respectively corresponding wavelengths from the three distinct wavelengths; and
determining the descriptor of the surface based on a product of said first, second, and third data.

8. A method according to claim 7, wherein the determining the descriptor includes
forming an image of the object based on the product of said first, second, and third data;
determining a fringe of said image corresponding to light that has traversed substantially equal optical paths corresponding to the three distinct wavelengths; and
determining a contour of the surface of the object from said fringe;

9. A method according to claim 8, wherein the determining the descriptor further includes
determining a figure of merit characterizing roughness of the surface of the object based of deviation of a line corresponding to a center of said fringe from a straight line.

10. A method according to claim 7, further comprising
forming, on a display device, an image of the object based on the product of said first, second, and third data;
determining a fringe of said image corresponding to light that has traversed substantially equal optical paths corresponding to the three distinct wavelengths; and
axially moving the interference objective with respect to the surface of the object to keep said fringe substantially in a center of a field-of-view (FOV) of the optical detector.

11. A method according to claim 7, further comprising
varying a sensitivity of the sensor in measuring a distance between the objective and the surface of the object by changing an angular orientation of the interference objective with respect to the surface of the object.

12. A method according to claim 7, wherein the varying a sensitivity includes
forming an image of the object based on the product of said first, second, and third data;
changing an angular orientation of the interference objective with respect to the surface of the object such as
to position a first fringe, of said image and corresponding to light that has traversed substantially equal optical paths at the three distinct wavelengths, in a central portion of a field of view (FOV) of the optical detector; and
to position a second fringe of said image in a vicinity of an edge of said FOV, the second fringe being immediately adjacent to the first fringe.

13. A method according to claim 7, wherein the receiving includes the receiving of light with a color array detector.

14. A method for optically determining a descriptor of a surface of an object, the method comprising:
receiving, with an optical detector, light that has been reflected by the object and that has traversed an interference objective having an axis, the received light characterized by three distinct wavelengths;
acquiring, with a programmable processor, first, second, and third data from the optical detector, wherein said first, second, and third optical data represent interferometric images of the object formed in light at respectively corresponding wavelengths from the three distinct wavelengths;
forming, on a display device, an image of the object based on the product of said first, second, and third data;
determining a fringe of said image corresponding to light that has traversed substantially equal optical paths at the three distinct wavelengths; and
axially moving the interference objective with respect to the surface of the object to keep said fringe substantially in a center of a field-of-view (FOV) of the optical detector.
determining the descriptor of the surface based on said product of said first, second, and third data.

15. A method according to claim 14, wherein the determining the descriptor includes
determining a contour of the surface of the object based at least in part on said fringe.

16. A method according to claim 15, wherein the determining the descriptor further includes
determining a figure of merit characterizing roughness of the surface of the object based of deviation of a line corresponding to a center of said fringe from a straight line.
